(19) United States
(12) Patent Application Publication
(10) Pub. No.: US 2015/0128719 A1
(43) Pub. Date: May 14, 2015

(54) ASSEMBLY LINE QUALITY CONTROL CART AND METHOD

(71) Applicant: Comau, Inc., Southfield, MI (US)

(72) Inventor: Velibor Kilibarda, West Bloomfield, MI (US)

(21) Appl. No.: 14/538,038

(22) Filed: Nov. 11, 2014

Related U.S. Application Data
(60) Provisional application No. 61/902,976, filed on Nov. 12, 2013.

(51) Int. Cl. B62D 65/00; G01N 3/20; B23K 11/30

(52) U.S. Cl. CPC B62D 65/00; B23K 11/3063; B23K 11/3072; G01N 3/20
USPC 73/850; 29/791; 219/86.1; 29/402.08; 29/402.19

(57) ABSTRACT

Disclosed are assembly line equipment maintenance devices and methods. A maintenance cart is selectively engaged to a transport conveyor and integrated into a moving assembly line. The cart can include maintenance tools to refurbish robot end effector tools or replacement tools engageable by robot wrists. The maintenance or replacement tools can include a variety of maintenance equipment including weld tip dressing tools, weld force gauges, replacement weld guns, and test coupon disks.

### CROSS REFERENCE TO RELATED APPLICATIONS

This application claims priority to U.S. Provisional Patent Application Ser. No. 61/902,976, filed Nov. 12, 2013, which is incorporated herein by reference in its entirety.

### TECHNICAL FIELD

The present invention generally relates to the field of vehicle manufacture and assembly.

### BACKGROUND

Traditional high volume manufacture and assembly of machines and vehicles has occurred in large assembly plants. These assembly plants have included multiple assembly lines where components are gathered, assembled and connected together. In the manufacture and assembly of vehicular bodies, the bodies typically include a skeleton of sheet metal components that are welded together through resistance spot welding, seam welding and brazing techniques to form what are commonly called “body-in-white” (BIW) structures.

There is an ever growing need by vehicle manufacturers to increase the efficiency of vehicle assembly plants to build more vehicles and improve quality. Vehicle manufacturers have achieved higher levels of automation through use of automated assembly lines where industrial robots, powered conveyor systems and programmable control systems move the partially assembled vehicles along one or more assembly lines while automated equipment progressively assembles the vehicles or machines.

The high volume, nearly continuous operation of assembly plants takes a toll on the manufacturing equipment, particularly automated build and assembly equipment. In the assembly of vehicle sheet metal bodies, the automated equipment often includes perishable tooling, for example, robot-mounted spot welding guns which have welding tips that wear down and deform during assembly shifts. In present assembly devices and process systems, this equipment has to be temporarily taken offline to, for example, “dress” or reshape the spot weld gun tips which slow or stop the assembly line while these equipment maintenance procedures, repairs or replacements are taken care of. Where repair or replacement of equipment is required, even more disruption or stoppage or the assembly line is required.

Other devices and process steps to ensure the automated equipment is operating properly as designed also take place. For example, automated spot welding guns are periodically checked to ensure that they are producing proper welds between two or three pieces of sample sheet metal. Prior devices and quality check processes typically involved halting production, and through use of at least partially manual operations, a sheet metal sample, for example a test coupon or blank, would be inserted into, and the weld gun cycled, to produce a sample weld on the coupon which is then tested to ensure that weld gun is operating as designed. With hundreds of spot weld guns used in a large scale assembly plant, the above maintenance and quality control procedures can significantly affect the efficient operation of an assembly plant. This deficiency applies to many other pieces of equipment along typical assembly lines.

### BRIEF SUMMARY

The present invention provides an assembly line quality control and equipment maintenance device and methods for using the device and maintaining industrial equipment in a sequential assembly station environment.

In one example of the inventive device, an equipment quality control and maintenance cart is provided which is integrated with a sophisticated assembly line and selectively employed to travel along the assembly line and assembly cells thereby providing the maintenance equipment directly to the equipment in need of maintenance or replacement.

In one example, the maintenance cart is removably connected to an overhead transport system and is selectively transitioned into the assembly line and sequentially moved from assembly cell to assembly cell. The maintenance cart includes a plurality of assembly cell equipment maintenance equipment, for example spot weld gun weld tip dressing tools, which the weld guns at each station automatically cycle to the tools and which perform the required maintenance, for example dressing or reshaping the weld gun tips.

In another example, the maintenance cart includes replacement equipment, for example full weld gun end effectors, which the industrial robots at an assembly cell remove from the cart and swap out a damaged weld gun with an operable one.

In one example, the maintenance cart includes a test coupon disk device. In one example, the coupon disk device includes predetermined test samples to test the operability of predetermined equipment to provide present and historical data on the operability of assembly cell equipment. The readily available recordation or visualization of historical data provides advantages of identifying equipment problems before unacceptable performance or failure occurs requiring stoppage of the line.

In one example, the maintenance cart is stored adjacent to and in ready re-engagement with the assembly line for selective insertion into the assembly line, when needed or at predetermined intervals, to proactively or adequately address known maintenance issues thereby decreasing line inefficiency, reducing downtime due to maintenance or repairs, and increasing the efficiency and productivity of the assembly line.

In one example of a method of operation, maintenance and quality control tools are loaded or secured onto a maintenance or quality control cart. The equipped cart is selectively inserted into the assembly line and connected to the existing power transport device used for the assembly line. The cart is moved along the assembly line through sequential assembly cells wherein the automated equipment is programmed to access the maintenance and quality control tools to maintain or check the operating performance of the assembly cell equipment. When not in use, the cart can be easily removed from the assembly line and temporarily stored adjacent to the assembly line until re-inserted for another maintenance or quality control cycle.

The present invention improves on deficiencies in prior devices and methods which provides benefits of improved equipment performance; increases assembly line jobs per hour (JPH) output; improves quality of the assembled product; reduces defective builds, rework and scrap; reduces complexity and programming of robotic devices; provides monitoring of important assembly process parameters; generates periodic data and records of processes for quality monitoring and control and reduces and simplifies maintenance equipment and procedures.

### BRIEF DESCRIPTION OF THE DRAWINGS

The description herein makes reference to the accompanying drawings wherein like reference numerals refer to like parts throughout the several views, and wherein:

FIG. 1 is a schematic perspective view of an example of the inventive assembly line maintenance cart;

FIG. 2 is a schematic example of an assembly plant floor plan useful with the example of the maintenance cart in FIG. 1;

FIG. 3 is a schematic elevational view of a portion of an assembly line in FIG. 2;

FIG. 4 is an elevational view of an example of an assembly cell shown in FIG. 3;

FIG. 5 is an end elevational view of the assembly cell shown in FIG. 4;

FIG. 6 is an enlarged partial end elevational view of the assembly cell shown in FIG. 5;

FIG. 7 is a plan view of the assembly cell shown in FIG. 5;

FIG. 8 is a schematic perspective view of an example of a test coupon disk useful with the invention shown in FIG. 1;

FIG. 9 is a schematic elevational view of an example of the assembly cell shown in FIG. 3;

FIG. 10 is a perspective view of an alternate maintenance cart and transport device than as shown in FIG. 1;

FIG. 11 is a perspective view of an alternate example of the maintenance cart shown in FIG. 1 using a pallet transport device;

FIG. 12 is a schematic perspective view of an example of a transport device and positioning device useful with the maintenance carts shown in FIGS. 1 and 11;

FIG. 13 is schematic end elevational view an example of a portion of the transport device shown in FIG. 12;

FIG. 14 is an alternate plan view of the example shown in FIG. 7;

FIG. 15 is a schematic plan view of the example shown in FIGS. 7 and 14;

FIG. 16 is a schematic flow chart of an exemplary process of the invention;

FIG. 17 is a schematic elevational view of an example of an alternate maintenance cart having a standing platform for an operator to access elevated assembly line equipment; and

FIG. 18 is a schematic side view of the maintenance cart shown in FIG. 17.

### DETAILED DESCRIPTION OF EMBODIMENTS OF THE INVENTION

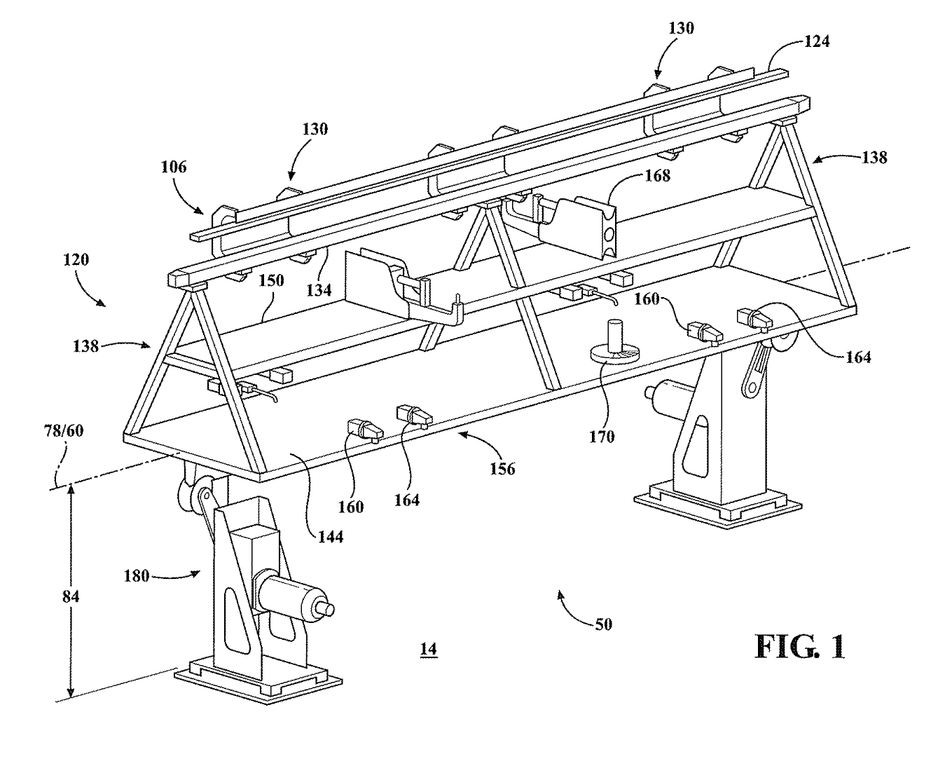

Referring to FIGS. 1-18, examples of an assembly line quality control and maintenance cart device and system for checking the performance and maintaining industrial equipment systems along an assembly line is explained and illustrated below.

Referring to FIG. 1, an example of an assembly line maintenance cart 120 is illustrated in use with an overhead transport assembly 106 and various tools for maintaining and replacing automated assembly cell equipment as described further below.

In an example maintenance system 10, a maintenance cart 120 is used with the same transport assembly, for example 106, used to move the progressively built vehicle bodies along the assembly line 40 as further described below. In the example, the transport assembly 106 includes a rigid rail 124 and powered roller system (not shown). A suitable overhead conveyor is present assignee's VersaRoll brand conveyor. In the VersaRoll system, the rigid rail connected to the carriage, in this example cart 120. The rigid rail is engaged with powered rollers on the frame structure which selectively move the cart 120 along the path of travel according to preprogrammed instructions in a control system. Additional details can be found in U.S. Pat. Nos. 6,799,673; 6,564,440; 6,719,122 and U.S. Patent Application Publication 2012/0304446 which are assigned to the present assignee and incorporated herein by reference. The cart 120 includes arms 130 that engage rail 124 to suspend the cart 120 as generally shown. Exemplary cart 120 further includes a cross beam 134 connected to the arms 130 and a frame 138 which supports lower deck 144 and an upper deck 150 as generally shown. The A-configured frame 138 is intended to provide maximum access space for industrial robots and other equipment to access the tools on the lower 144 and upper 150 decks for maintenance and other processes described below.

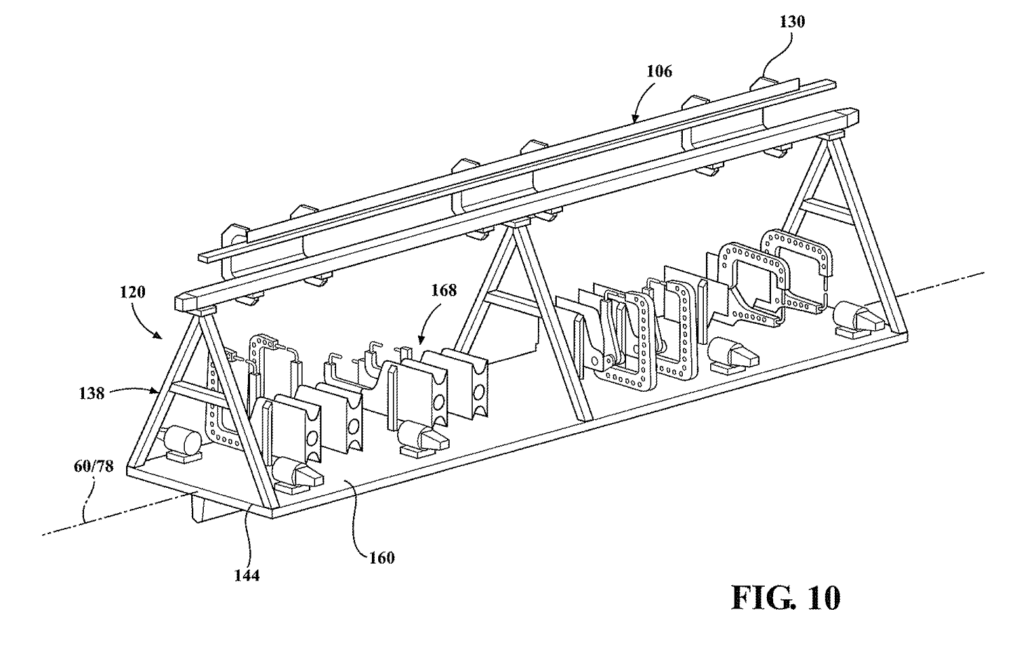

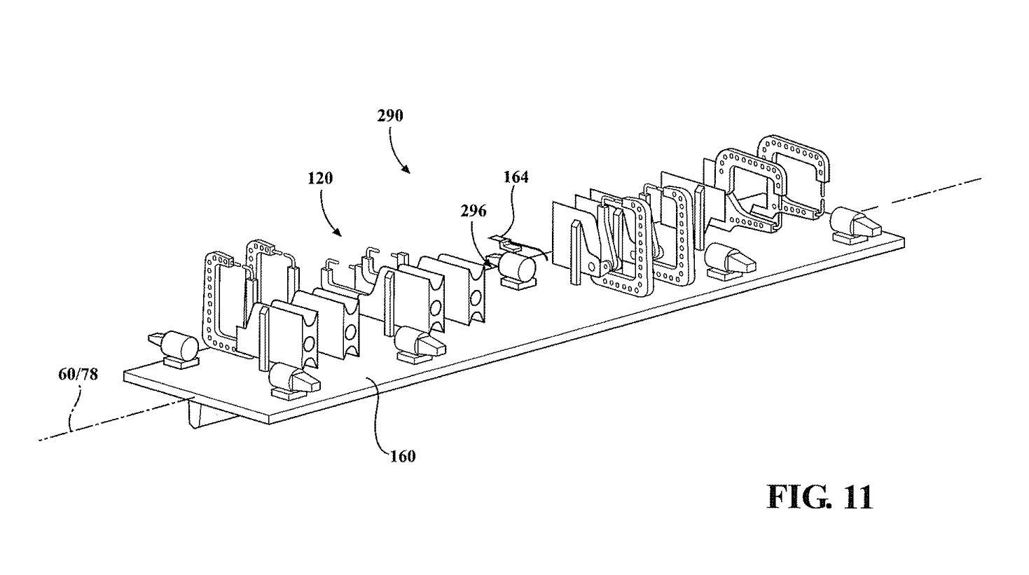

Referring to FIG. 10, an alternate example of a quality control or maintenance cart 120 is shown. In the example, only a first deck 144 is used. It is understood that different configurations of cart 120, for example more or less decks 144 and 150, different frame structures 138 and different connection equipment and methods for connecting cart 120 for transport along an assembly line 40 to suit the particular application and plant environment known by those skilled in the art may be used. As described below and illustrated in FIGS. 11-13, system 10 and a cart 120, in the same or a different configuration, may be in the form of a pallet-type transport device mounted closer to the assembly plant floor where the assembly plant assembly line is equipped with such a conveyor or transport device.

Referring to FIG. 1, in the example cart 120, maintenance tools 156 and replacement components for automated assembly cells 56 equipment are secured to and/or positioned on one of the decks 144 or 150. In an example of maintenance tools useful to service and/or maintain vehicle BIW assembly through assembly cells employing robotic resistance spot welding guns, maintenance tools 156 for cart 120 may include weld tip dressing tools 160, force gauges 164, replacement weld guns 168 and one or more test material coupon disks 170 (further described below). Other maintenance tools on cart 120 may include inspection cameras or image taking devices (not shown). For example, cameras or video taking devices can be mounted to the cart and either fixedly mounted or remotely movable by an operator to take images or video of selected areas of the assembly cell or equipment for inspection purposes. The images taken by the devices could be sent to a remote location in the plant or central location for examination. In one example, a camera may take high resolution images of test coupons 178 discussed below versus a manual visual inspection by an operator. Other uses for image recording devices known by those skilled in the art may be used. Further maintenance or replacement tools such as process equipment replacement cradles may be used on cart 120 as known by those skilled in the art.

It is understood that other maintenance tools 156, for example electrical current measuring devices, vision or camera systems, process equipment replacement cradles and other maintenance, quality or replacement tools suitable for the particular assembly line 40, assembly cells 56 and industrial equipment therein known by those skilled in the art may be used. The system 10 and cart 120 can be used with industrial equipment other than spot welding equipment. For example, system 10 and cart 120 can be used seam (MIG) welding lines, adhesive application lines, material handling lines, mechanical rivet application lines, and other assembly and process lines known by those skilled in the art.

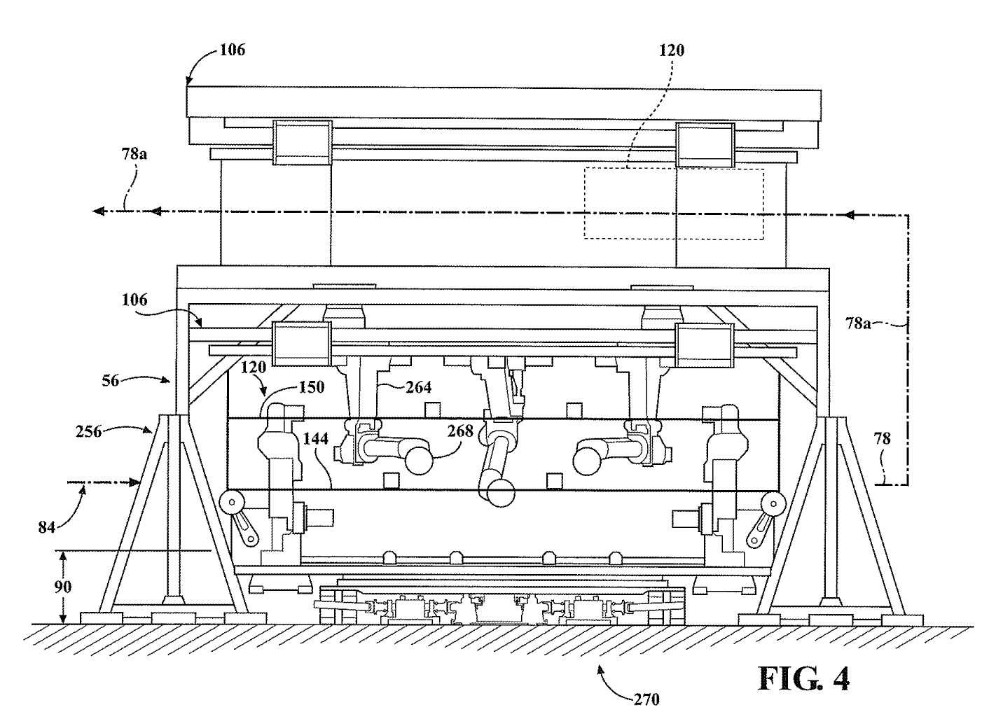

In the example shown in FIG. 1, using weld tip dressing tools as an example, several dressing tools may be longitudinally and/or vertically spaced on lower 144 and upper 150 deck to suit the location and range of movement of the robotic weld guns in the assembly cells 56. As further described below, in an example of the scaffolding assembly structures 256 shown in FIGS. 4, 5, 7 and 9, the weld tip dressing tools 160 are positioned on cart 120 so each robot 264 can reach and insert the weld gun tips into a respective tip dressing tool 160. In a similar manner, the other maintenance tools are placed and/or secured on a deck to be accessible by the particular equipment that the respective maintenance tool is designed to function with. It is understood that different tools and placement on the cart 120 known by those skilled in the art can be used.

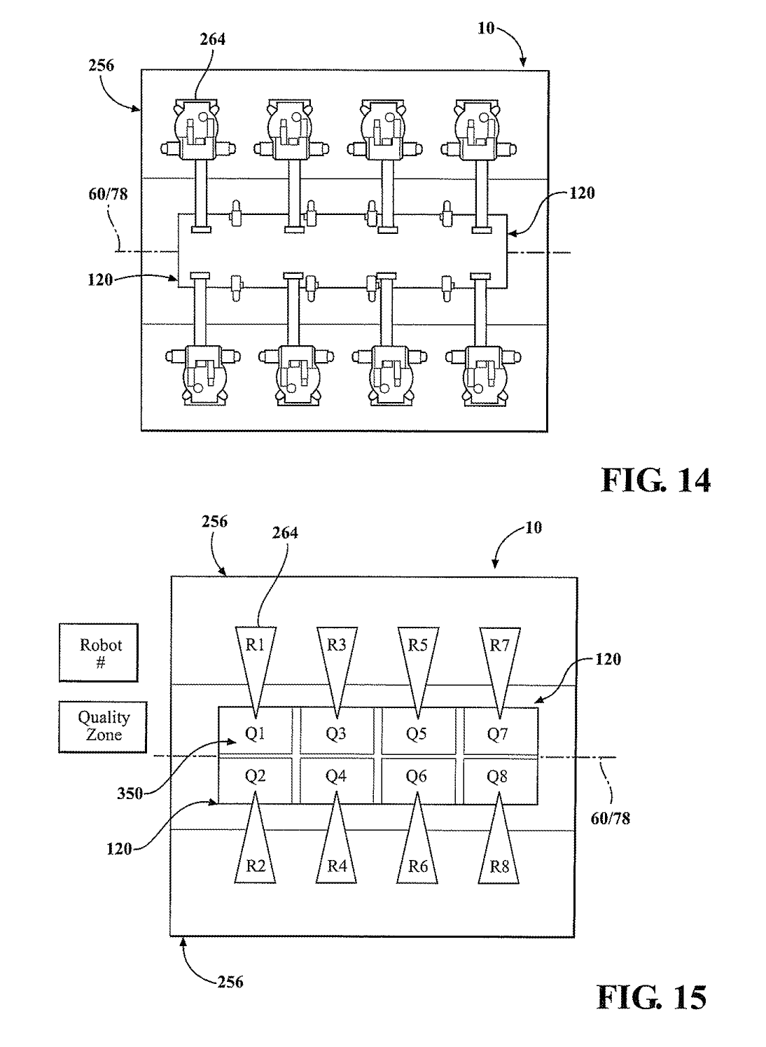

In one example shown in FIGS. 14 and 15, cart 120 can be setup to include quality or maintenance quadrants 350 (labeled Q1-Q8 in FIG. 15). In the example, each quadrant 350 is oriented and equipped with quality or maintenance tools 156 within the range (R1-R8) of motion of a particular robot 264 or other industrial equipment. Depending on the particular assembly cell 56, these quadrants 350 can be similarly equipped for each robot 264 or differently to suit the particular assembly line or assembly cell. Other quadrants 350 or zones for system 10 and cart 120 known by those skilled in the art may be used.

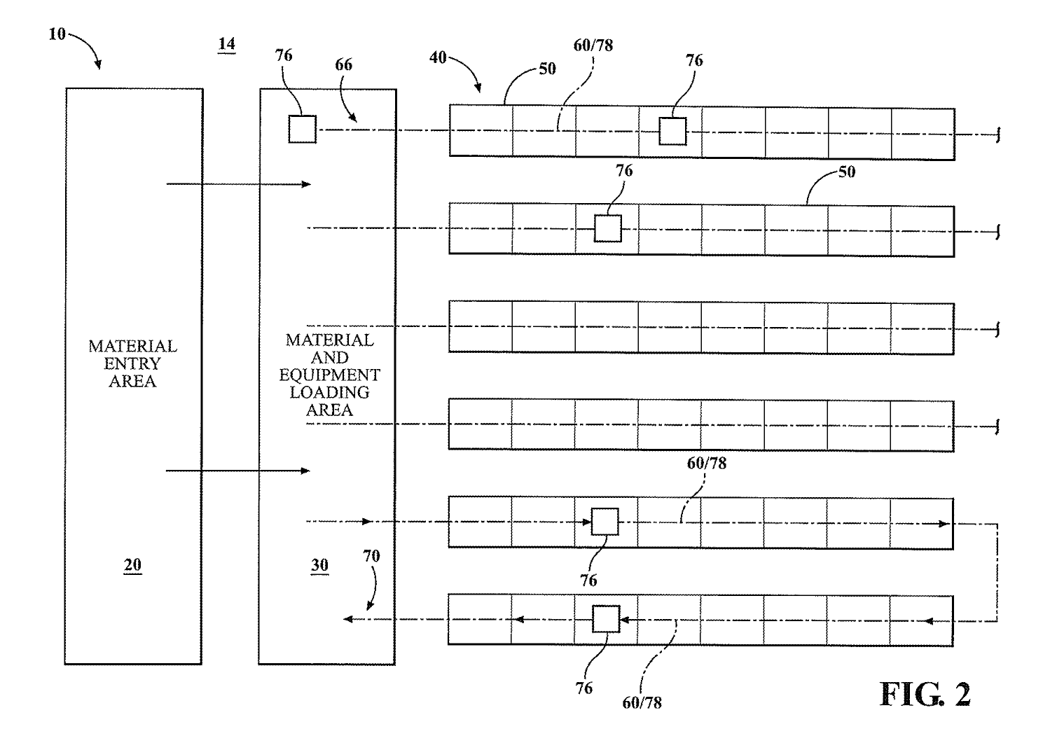

Referring to FIG. 2, an example of an assembly plant 14 for body-in-white (BIW) vehicle body structures that is useful with the system 10 is shown. In the example, the system 10 is particularly, although not exclusively, useful with an assembly plant having a material entry area 20, a material and equipment loading area 30, and a plurality of main assembly lines 40 (six shown in FIG. 2 as illustrated). Each assembly line 40 includes a plurality of assembly cells or build stations 56 along an assembly path 60 running down each assembly line 40. An example of a suitable assembly plant layout design is the ComauFlex system by assignee of the present invention. Additional details can be found in U.S. Pat. Nos. 8,201,723; 8,713,780; 8,869,370; and U.S. Patent Application Publication 2012/0304446 all assigned to the present assignee and all are incorporated by reference.

Referring to the example in FIG. 2, simplified for purposes of illustration, there is an assembly line starting position 66 and an ending position 70 with assembly path 60. In the example shown, each individual assembly line 40 includes an independent vehicle build assembly path 60 beginning in the material and equipment loading area 30 and ending at the opposite end of the line for simplicity purposes of illustration only. The last two lines illustrated at the bottom of FIG. 2 illustrate a loop or serpentine assembly path 60 beginning on the assembly line 40 immediately above and ending at 70. It is understood that assembly lines 40 may be independent like assembly lines 40 illustrated toward the top of FIG. 2 or additional or all lines may form a continuous serpentine path as known by those skilled in the art. It is understood that other assembly line 40 configurations and plant layouts known by those skilled in the art may be used with the present invention.

In one example, material entry area 20 is a large area in the assembly plant 14 used for the warehousing and organization of individual vehicle sheet metal or BIW components or subassemblies of components (not shown) which are to be assembled and connected together at assembly cells or build stations 56 (eight stations for each assembly line 40 shown in FIG. 2 for ease of illustration only) at the assembly lines 40 to produce a product, for example, an automotive vehicle sheet metal body-in-white (BIW) 76. It is contemplated that many different components and subassemblies for different vehicle body types, for example different vehicle body types or styles A, B and C, are input, organized and stored in material entry area 20 until needed for production build of the vehicle body 58. The material entry area 20 has suitable ingress and egress points to easily move large quantities of components and subassemblies into and out of the area 20 as needed. Other features such as storage racks and other logistical, inventory and organizational features known by those skilled in the art may be used. It is understood that more or less assembly lines 40 and assembly cells 56 per line may be used as known by those skilled in the art.

Referring to FIGS. 1, 3 and 4, an example of a maintenance cart 120 useful with an overhead transport assembly 106 is generally illustrated. In a summarized preferred example, the system 10 provides a maintenance cart 120 having tools delivered directly to the assembly cells 56 to assist in the maintenance or replacement of equipment at assembly cells 56 along the assembly line 40. The maintenance cart 120 is selectively inserted directly into the assembly line per a predetermined maintenance schedule or as needed for efficient operation of the assembly line 40.

In the example shown in FIG. 2, maintenance cart 120 cart path 78 is substantially aligned along/over the vehicle body assembly path 60. Cart path 78 begins in the material and equipment loading area 30 and extends into the production and main assembly line 40. In the exemplary use of system 10, a plurality of vehicle body transports devices, for example carriages connected to an overhead transport assembly 106 are sequentially loaded with individual components and/or subassemblies in material and equipment loading area 30 where the carriages are positioned at a first or load stage height 80 where workers (shown) or industrial multi-axis robots (not shown) sequentially load the carriages with vehicle-specific parts. In this system, maintenance cart 120 can also be loaded or equipped with maintenance tools and replacement tools as further discussed below.

The vehicle body carriages are connected to and powered along the cart path 78 preferably by the same overhead conveyor transport assembly 106 used throughout the loading and building process discussed in detail below. In an application using the inventive maintenance cart 120, the cart 120 can selectively be inserted into the sequence of carriages and equally travel along the path of travel 60/78 just as the vehicle body transports are progressed.

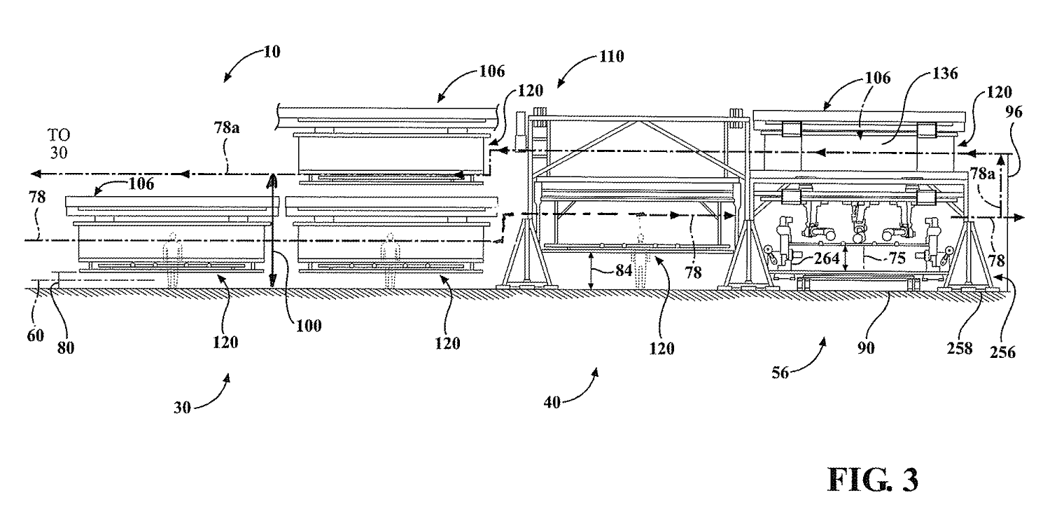

Referring to FIG. 3, the progression of a maintenance cart 120 along the vehicle assembly path 60 and the substantially aligned cart path 78 is illustrated. In the example illustrated, on nearing an assembly cell 56, an elevator device 110 raises the maintenance cart 120 and secured tools to a second or cell load height 84 and then transferred into the assembly cell 56 and in engagement with a deck lift device 180 best seen in FIG. 1 and discussed in further detail below. In a preferred example as best seen in FIGS. 1, 4, 5 and 6, the lift device 180 engages and further supports the cart 120 lower deck 144 while the assembly cell maintenance equipment processes are conducted as further discussed below. It is understood that cart 120 may remain at a constant height or level 84 from area 30 through the assembly cells 56 and/or return height 96. It is understood that system 10 can be used without elevators 110 and simply be used with the existing vehicle transport system designed for the assembly plant or assembly line that the system 10 and cart 120 will be utilized.

On completion of the predetermined maintenance operations in the assembly cell 56, the transport assembly 106 moves the cart 120 progressively to the next assembly cell 56 in lock-step with the normal movement of the assembly line 40 along path 60/78.

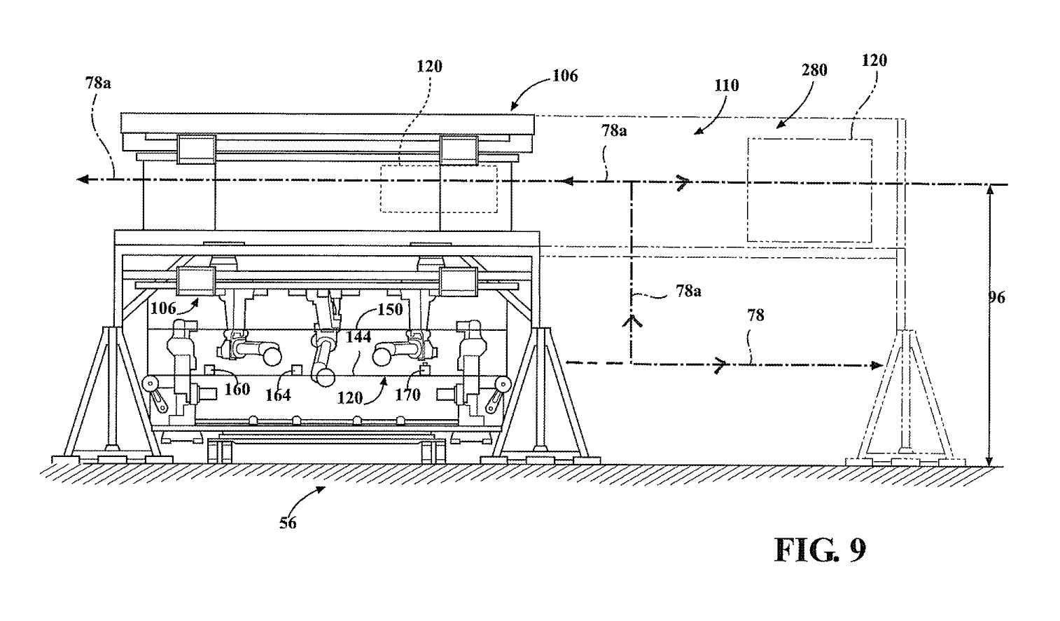

As shown in the exemplary application of cart 10 as best seen in FIGS. 3 and 9, at the end of a particular assembly line, for example 40, when the quality control, maintenance tools or replacement tools 156 on cart 120 need to be serviced or replenished with alternate or new tools, cart 120 may be elevated along return path 78a by a second elevator 110 shown in FIG. 9 to a high return or fourth height 96 as best seen in FIG. 4. The cart 120 then reverses direction back toward material and equipment loading area 30 for replenishment and/or temporary storage until the cart 120 is reinserted into the assembly line for another maintenance cycle. In a one example shown in FIG. 3, on the return path 78a, cart 120 is lowered to a fifth or lower return height 100 through an elevator device (not shown) to complete travel back to material and equipment loading area 30. Throughout the above-described path, the cart 120 preferably use the same transport assembly 106 as that used for the vehicle body support devices (carriages or pallets) providing for a coordinated, controlled and integrated process for maintaining and replacing perishable tooling at the assembly cell 56 along a respective assembly line 40. In an alternate example, the maintenance cart 120 may travel to the next adjacent assembly line 40 and continue along in a loop or serpentine cart path 78 until the end of the line 70 as generally described above. It is understood that cart 120 may travel along path 78a back to area 30 along a constant height, for example, 96 without further raising or lowering the cart to another height, for example height 100 as described. In one example of system 10, only a single elevator 110 would be used at the end of an assembly line to raise cart 120 to the upper return line 78a to area 30 or other predetermined area.

In an alternate example shown in FIG. 9, instead of cart 120 automatically returning to material and equipment loading area 30, or other area for service for temporary removal from the assembly line, a holding area 280 may be used for such temporary removal of cart 120 from the assembly line process until inserted back into the line. In the example, holding area 280 may also serve as an area to service, refurbish or replace additional components instead of material and equipment loading area 30 as described in the example above. Other areas for temporary holding and storage of the cart 120, and processes for work on and replenishment of cart 120, known by those skilled in the art may be used.

In one example of a method for using system 10 and the exemplary cart 120, movement of components and subassemblies between material entry area 20 and material and equipment loading area 30 may be by traditional means, for example fork lift devices (not shown). In other examples, one or more floor-level or elevated conveyors (not shown) may be used to transfer bins, crates or pallets to selected positions in material and equipment loading area 30.

In material and equipment loading area 30, maintenance cart 120 is preferably engaged to an overhead conveyor transport assembly 106 which is used throughout the main assembly line 40 so that no transfers to other conveyors or transport systems are necessary providing for seamless loading and insertion of cart 120 from the material and equipment loading area 30 to the assembly line 40 and back to the material and equipment loading area 30 to repeat the process. A suitable example of an overhead transport assembly 106 to engage and transport maintenance cart 120 is the VersaRoll brand conveyor sold by Comau, Inc. assignee of the present invention. Examples of these programmable and powered overhead transport systems and carriages are described in U.S. Pat. Nos. 6,799,673; 6,564,440 and 6,719,122 and US Patent Application Publication No. US 2012/034446 A1 which are incorporated herein by reference. Other overhead and floor-based conveyors, automated guided vehicles (AGVs), and transport systems known by those skilled in the art may be used. In an alternate example, maintenance carts 120 may be equipped with the maintenance tools 156 and replacement components, for example weld guns 168 in another location in the plant, for example a tool crib or maintenance equipment area (not shown) and then the cart 120 is moved to material and equipment loading area 30 to be inserted into the vehicle assembly sequence for travel along the path 60/78.

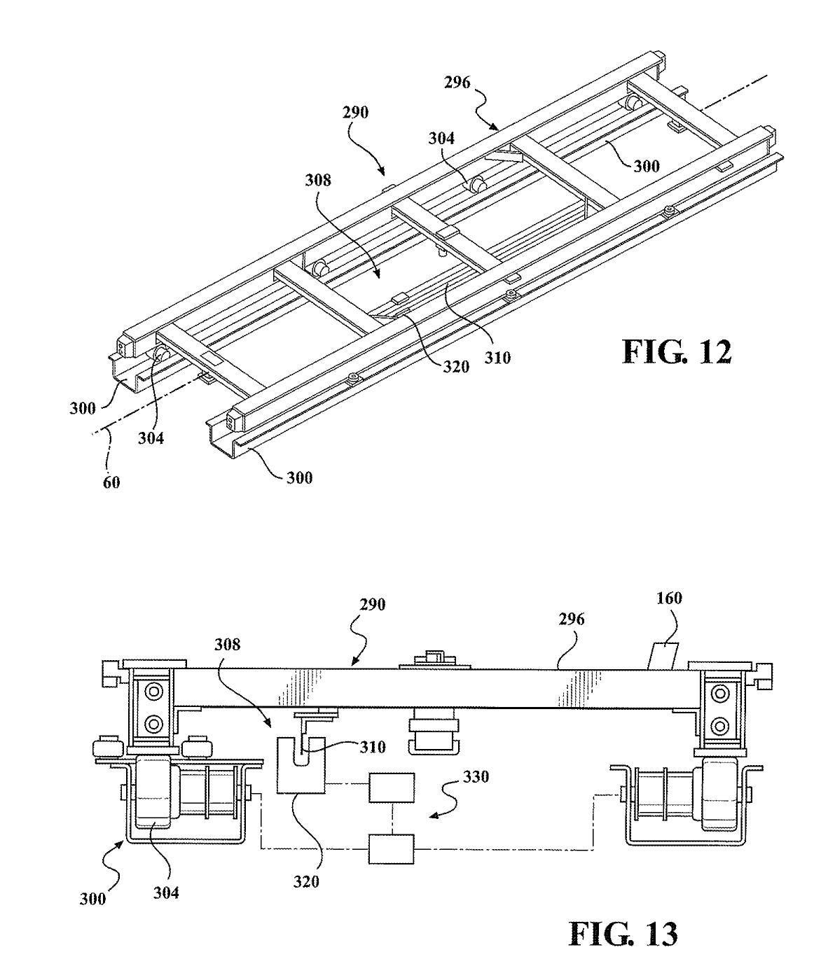

In an alternate example of a conveyor transport device shown in FIGS. 11-13, a pallet-style transport assembly 290 may be used with system 10 and cart 120. In the example, a pallet 296 is supported on rails 300 having a powered rollers 304 connected to one or more motors 306 to power and move the pallet 296 and connected cart 120 (not shown) along the assembly line as shown. In FIG. 12, pallet-style transport assembly 290 may include a coded strip 310 readable by a reader 320 for use in a closed-loop system to monitor and precisely control movement of the pallets 296 along the assembly line. This reader system is further useable with the conveyor transport assembly 106 described above. Suitable conveyor systems include the VersaRoller and VersaCoder systems produced by Comau, Inc., assignee of the present invention. Further details may be found in U.S. Pat. Nos. 7,232,027 and 7,108,189 the entire contents of which are incorporated by reference. In the VersaPallet system, a track or rails are secured to the floor of an assembly plant and include powered rollers. The pallets which typically carry or support partially assembled vehicle bodies engage the rollers and are selectively moved along an assembly path of travel according to preprogrammed instructions in a controller controlling the powered rollers. In the described VersaCoder system, an elongate encoded strip with information is connected to each carriage or pallet and passes through a reader positioned at each assembly cell. Through identification of the carriage/pallet and or item supported thereon, the powered rollers are selectively engaged in a preprogrammed, closed-loop feedback system to move and accurately position the pallet/carriage in a desired position, or multiple positions, at a particular assembly cell.

Such transport and conveying devices may be controlled by individual or centralized control systems which are preprogrammed to control and monitor the movement of the conveyor transport assembly 106/290, carts 120, robots and other plant equipment associated with the vehicle and/or kit carts connected thereto. Such control systems may be powered and exchange information directly through traditional means such as wire harnesses or may communicate through wireless, cloud-based communication systems and protocols. One example of such wireless or cloud-based system includes U.S. Patent Publication No. US 2010/0241260 assigned to the assignee of the present application and incorporated herein by reference.

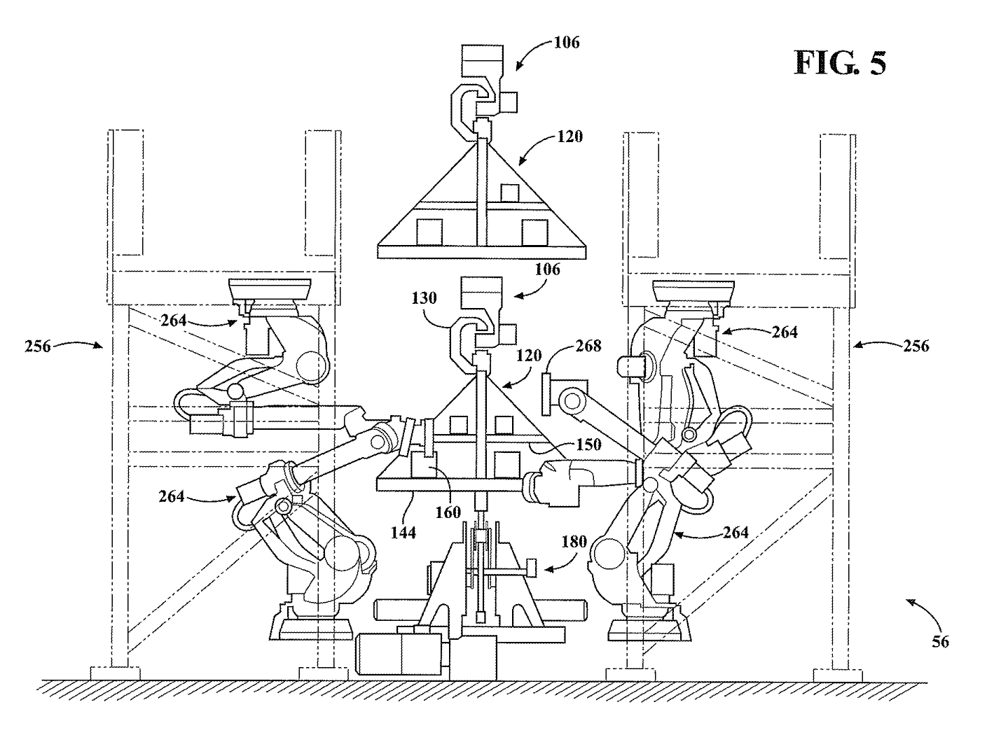

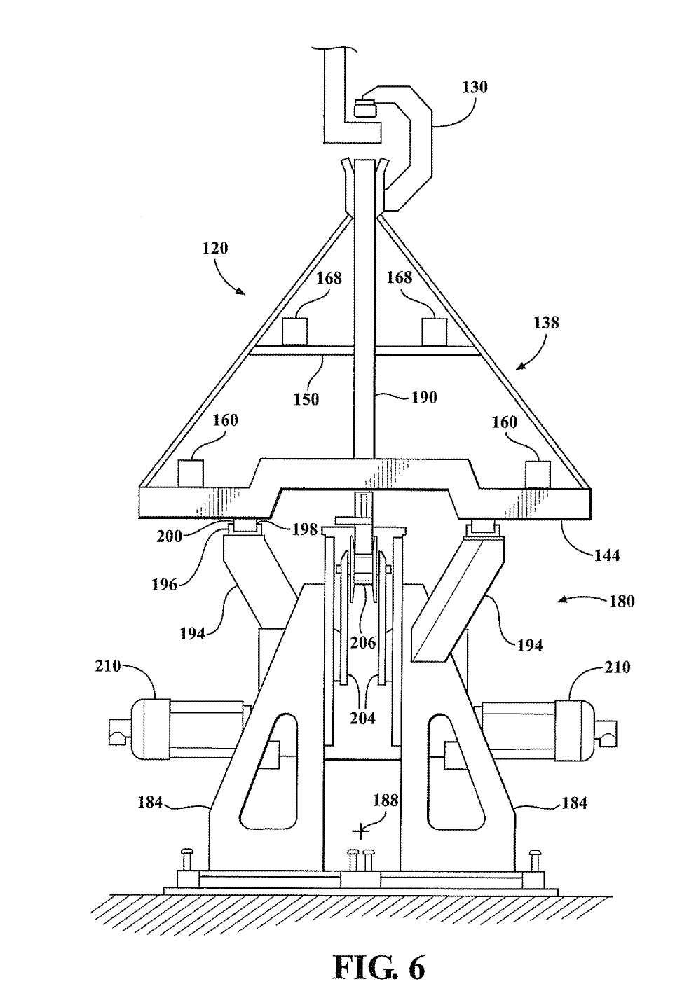

Referring to FIGS. 5 and 6, in an alternate example of system 10 where it is desirable to have the cart 120 positioned lower in the assembly cell for execution of the maintenance or quality processes, each one or more of the assembly cells 56 may include a pair of deck lifts 180 mounted to the assembly plant floor. Deck lift 180 includes a pair of upstanding pillars 184 that symmetrically positioned about a centerline 188 which is generally in alignment with cart path 78 and assembly path 60. Each pillar 184 includes a rigid support arm 194 angularly extending from the pillar and including guide block 196 defining a channel 198. The guide block 196 and channel 198 coordinate with a guide rail or form 200 positioned along the underside of the lower deck 144 as best seen in FIG. 6. The guide blocks 196 and channels 198 serve to accurately and precisely guide and position the cart 120 in the assembly cell. Further details of the exemplary lift device 180 can be found in U.S. Pat. No. 6,719,122 assigned to the assignee of the present invention, the entire contents of which is incorporated herein by reference. Sensors and controllers (not shown) to monitor the positional location of the cart 120 along cart path 78 and most importantly in the assembly cell 56, may be used. A suitable example of a highly accurate positional system useful with conveyors and transports is marketed under the brand VersaCoder by Comau, Inc. assignee of the present invention and is disclosed in U.S. Pat. No. 7,108,189 the entire contents of which is incorporated herein by reference.

Each deck lift pillar 184 further includes a rotatable lift arm 204 and a support wheel 206 electrically connected to a motor 210 which selectively rotates arm 204. Wheel 206 engageably receives a portion of lower deck 144 (not shown) of the cart 120 when the cart 120 is positioned in the assembly cell 56.

As best seen in FIGS. 4, 5, 7 and 9, a preferred example of assembly cell 56 useful with the maintenance device and system 10 including cart 120 includes an assembly structure or scaffold 256 positioned on each side of the assembly path 60 and cart path 78. Each structure 256 includes a frame 258 supporting and housing a plurality of industrial, multi-axis robots 264 for use in the assembly operations to be conducted in the cell. In the example shown, some robots 264 are suspended from the frame 258 further reducing congestion on the assembly plant floor. In the example, an upper platform above the frame supports the necessary electronics and programmable controls to operate the robot and other electrically powered devices for a substantially self-contained and modular cell. Industrial robots 264 used to pick up and position parts to create subassemblies or to progressively build vehicle bodies 76.

In a common example, robots 264 may include interchangeable end effectors 268 which weld, glue, include fixtures to hold or position parts or otherwise connect the parts together suitable for the assembly operations in the cell. One example of an end effector is a resistance spot welding gun 168 shown in FIG. 1. A suitable example of an assembly cell structure is disclosed in U.S. Pat. No. 8,201,723 assigned to assignee of the present invention. An example of changeable end effectors on an industrial robot is described in U.S. Patent Application Publication No. US 2010/0180711 assigned to the Assignee and is incorporated herein by reference. Other assembly cell structures known by those skilled in the art may be used.

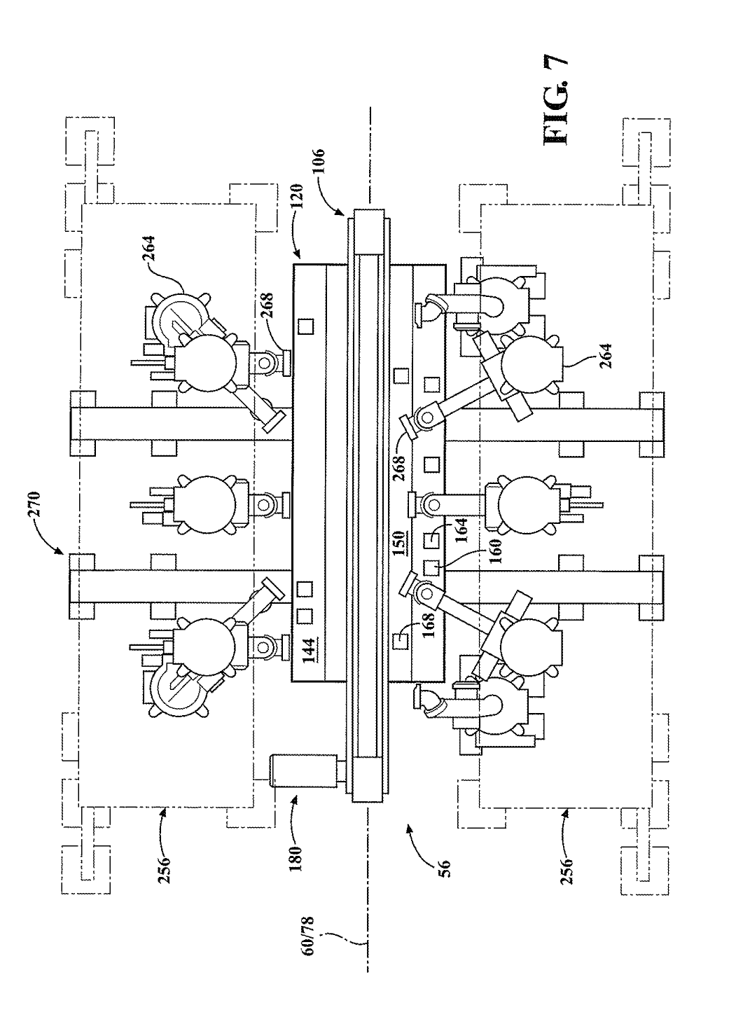

As best seen in the examples shown in FIGS. 4, 5 and 7, when a maintenance cart 120 enters assembly cell 56 by transport assembly 106, the cart 120 is preferably positioned at a second or cell load height 84 as generally illustrated in FIGS. 4, 5 and 6. In this position, the robots can access and engage the maintenance tools, for example weld gun tips can be dressed/reformed using tip dressing tools 160 secured to the lower deck 144 as generally shown in FIG. 1. In such an example, several tip dressing tools 160 can be positioned and longitudinally spaced to coordinate with the position of the suspended robots 264 on both sides of the line as best seen in FIGS. 5 and 7. The robots can be programmed to conduct a maintenance cycle wherein the robots 264 are programmed to insert the respective weld gun tips into the aligned weld tip dresser connected to the cart to dress the tools back to a designed or specified condition. If six robots 264 are used in a scaffolding assembly structure 256, six tip dressing tools 160 can be secured to one of the cart 120 decks within the range of movement by the respective robot. With the precise positioning of the cart 120 possible through the transport and positioning devices identified above, and precise and programmable control of the robots 264, in this example, the robots can be programmed to automatically cycle when cart 120 is in position in the assembly cell 56 to dress the weld gun tips on a scheduled basis with little or no human intervention or supervision needed.

The robots 264 can be cycled through a preprogrammed maintenance sequence of movements with cart 120 when cart 120 enters an assembly cell 56. Recognition or signaling of the entrance or position of cart 120 in an assembly cell which can trigger or initiate movement of the robots through a series of movements to engage one or more maintenance tools or to engage replacement end effector tools can be achieved in many ways. For example, the cart 120 may include a coded information strip that is read by a scanner or reader for precisely and accurately positioning the cart 120 where desired for the maintenance movements of one or more robots. An example is the VersaCoder® brand system by Applicant described in U.S. Pat. No. 7,128,189 which is incorporated herein by reference. Other devices and systems to recognize or detect entrance or position of cart 120 in an assembly cell such as manual proximity-type switches, electronic scanners, laser sensors, manual triggers by operators and other methods known by those skilled in the art may be used.

In an alternate example, for example if a weld gun 168 is not functioning properly or fails, cart 120 can be inserted into the assembly line and provide a replacement weld gun 168 as generally shown in FIG. 1. The robot 264 holding the defective weld gun can release the defective weld gun on the upper deck 150 and engage a new or refurbished weld gun 168 from cart 120 with little or no delays in the continuing sequence of the assembly line. As noted, other maintenance tools, replacement equipment and processes for system 10 and cart 120 known by those skilled in the art may be used.

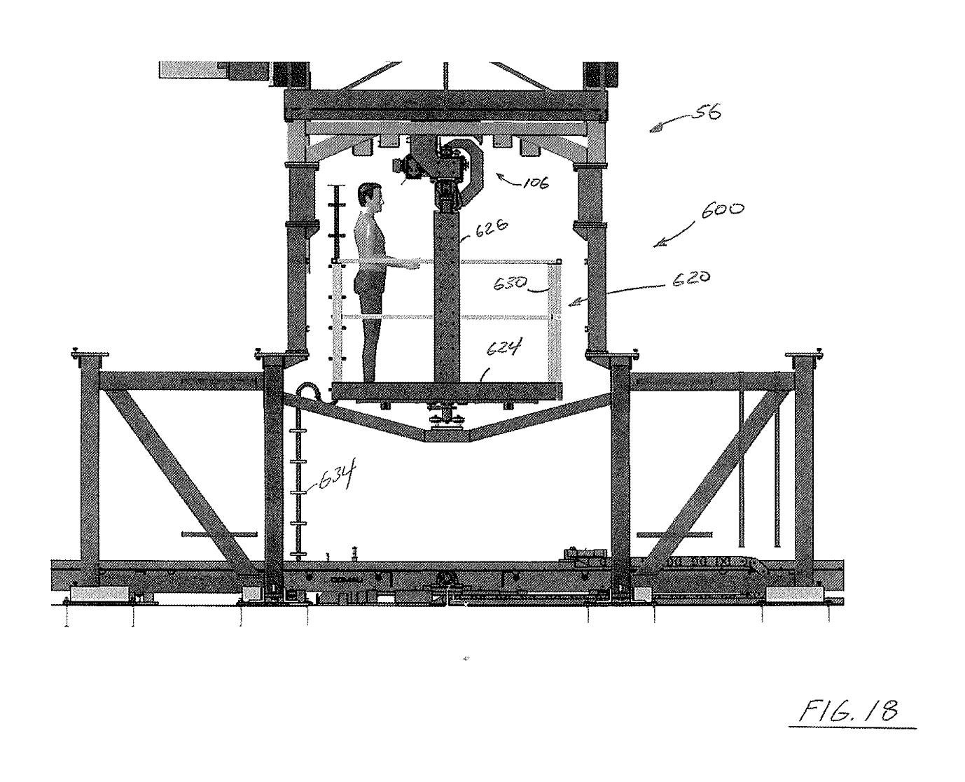

Referring to FIGS. 17 and 18, an alternate example 600 of maintenance cart 120 is shown. In the example, maintenance cart 120 is in an alternate form of a standing platform 620 wherein an operator can safely stand on and move about a platform or floor 624 which preferably spans and is positioned between part racks 626 as generally shown. The exemplary alternative maintenance cart may be a modified design from that described in U.S. Patent Application Publication 2012/0304446 assigned to the present assignee the entire contents of which is incorporated herein by reference.

In the example alternate cart 620, platform 624 has a safety rail 630 surrounding substantially the entire perimeter. Preferably a portion of rail 630 is hinged or otherwise indexable so that a ladder 634 can be used by an operator to easily climb to the height of the platform 624 as generally shown. Other alternative structures to rail 630 or methods to access and ingress or egress cart 620 known by those skilled in the art may be used. It is contemplated that once an operator is positioned in cart 620, the cart 620 may be indexed down the line along path 78 to the subsequent assembly cells to access equipment which it is safe and convenient to do so.

In an alternate example not shown, cart 620 may be in the form of an alternate pallet shown in FIG. 11 with a suitable safety rail for accessing equipment associated with that type of a transport device.

Alternate maintenance cart 620 is useful to provide access to elevated and/or hard to reach equipment and can be inserted into the assembly line as that described for cart 120. The standing platform 620 provides advantages of providing a secure and safe suspended surface (or floor supported surface in pallet form) providing access to equipment used on the interior of an assembly line without having to move in bulky ladders, bucket scissor lifts or other support devices which can be difficult to position and may damage the expensive assembly line equipment in the assembly cell 56. Other devices, configurations and orientations of alternate maintenance cart 620 known by those skilled in the art may be used to achieve the advantages without deviating from the invention.

In an alternate example not shown, maintenance cart 120 could be in the form of a cart 120, preferably in a pallet-type form, that is selectively engaged with an automated guided vehicle (AGV) or automated guided cart (AGC) and selectively moved independent of the assembly line conveyor directly to a particular assembly cell for more targeted maintenance or replacement. The programmable AGV or AGC could be preprogrammed to travel on the assembly line floor on a predetermined path, preferably proximate the assembly cells, to deliver the required maintenance or accessory tools described above rather than integral with the assembly line conveyors as described above. Details of a suitable and exemplary AGC-type cart can be found in U.S. Patent Application Publication 2013/0325159 assigned to the present assignee the entire contents of which is incorporated herein by reference. In one example of an AGC, the programmable cart docks at an assembly cell or other location with a precision docking station. The AGC engages the docking station which places the AGC in precision located X, Y and Z coordinate locations so, for example, the maintenance and replacement tools on the engaged cart 120 are accurately and precisely positioned for access and predictable engagement by assembly cell or other robots to use the tools as described above. Other automated or programmable devices for selective movement of maintenance cart 120 known by those skilled in the art can be used without deviating from the present invention.

In one example, the maintenance cart 120 could be integrated into a sequenced line of carts carrying components for use on the assembly line, for example as described in U.S. Pat. No. 8,869,370. Alternately, the maintenance cart could be programmed to travel independently of assembly sequence or operation and directed to one or more assembly cells where, for example, robots could engage the maintenance or replacement tools or transfer them to accessible areas of the assembly cell 56 or assembly line. Other methods, constructions or configurations known by those skilled in the art may be used.

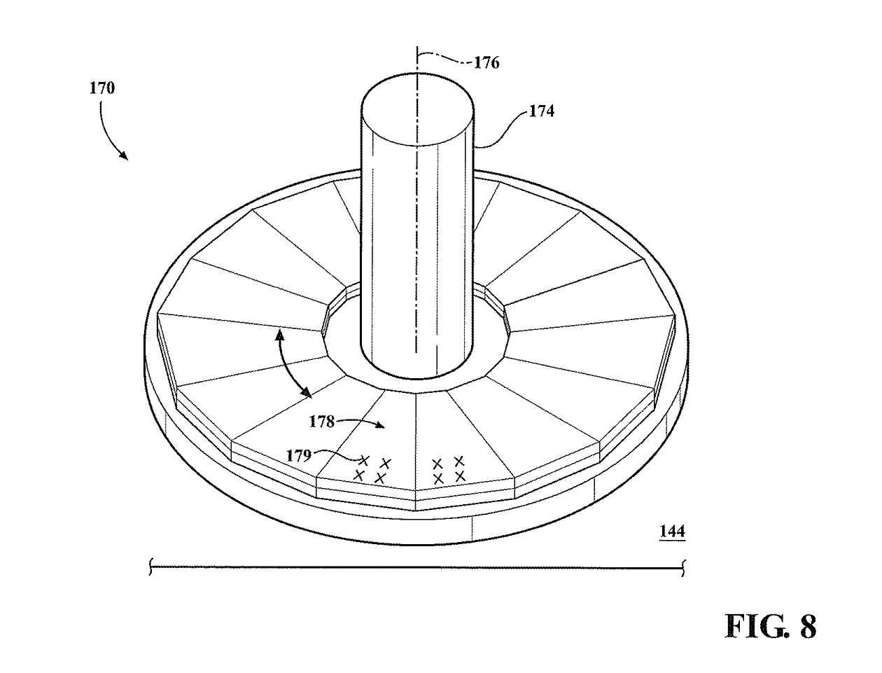

Referring to FIGS. 1 and 8, an example of a maintenance tool 156 in the form of a test coupon disk 170 useable with cart 120 is shown. The exemplary coupon disk 170 may be used to generate a plurality of actual spot weld, rivets or other fastening process samples from equipment positioned in assembly cells 56 as described above. The samples can be used, for example, to ensure the spot welding guns along assembly line 40 are producing quality welds to meet specifications. These test samples could then be evaluated or logged on a predetermined basis, for example hourly, to monitor critical process parameters and generate quality control records for selected or all assembly lines. It is understood that process testing of other than resistance spot welding guns may be used. For example, testing or suitable test coupons could be used for spot weld nugget quality or shape, proper current, proper force or clamping pressure, electrode alignment and other visual checks of the gun. Further, testing and coupons for sealing and adhesives; material handling such as electrical components and dress pack damage; MIG welding and brazing and mechanical fasteners such as rivets or material disruption processes such as staking or Tog-L-Loc-type processes can be used as well as others known by those skilled in the art without deviating from the present invention.

In the example, coupon disk 170 includes a base 172, a central column 174 providing an axis 176 of rotation permitting the base to rotate about the axis 176. In the example, a plurality of test coupons 178 are positioned on base 172 about the axis 176. For illustrative purposes, exemplary spot welds 179 are illustrated on the coupons. In the example, one or more coupon disks 170 are secured to one of the decks 144 or 150 of the cart 120 and move with the cart 120 along the assembly line as described above. In the assembly cell 56 shown in FIGS. 5 and 7, at least one coupon disk 170 would be positioned in each side of cart 120 for access by each array of robots 264.

In one example, the coupons 178 are sheet metal samples representative of the vehicle sheet metal layers and thicknesses which that particular weld gun functions to weld on vehicle bodies that pass through the particular assembly cell 56. Other configurations and orientations of coupon disk 170 and coupons 178 known by those skilled in the art may be used. For example, a long rectangular-shaped test coupon (not shown) could be used and indexed on cart 120 or the maintenance program programmed to index the equipment, so that side-by-side samples/cycles can be taken at a predetermined period, versus a rotating disk device as illustrated.

In one example of operation, when cart 120 enters an assembly cell 56 and it is desired to check the quality of one or more of the resistance spot welding guns, the robot 264 can be programmed to cycle and produce a spot weld 179 on a test coupon 178 that is presented to the weld gun when the cart 120 is detected to be positioned in the assembly cell 56 as previously described. In an alternate example, a test coupon for checking the quality of a connection by a rivet gun, for example expansion of the rivet or compression of the joint, may be included in system 10. Other fastening and joining processes may be included in system 10 as known by those skilled in the art.

Presentation or positioning of the test coupon 178 may be done in many ways known by those skilled in the art. For example, a test coupon 178 can be picked up from the disk base 172 and positioned by an adjacent robot 264 in a predetermined position within the range of motion of the weld gun to be tested. Alternately, coupon disk 170 can be configured or oriented so that the coupons are positioned to extend radially outward from the base or in another orientation so that the weld gun to be tested can generate the test spot weld on the test coupon 178 without having to remove the coupon from the base 172. Other methods of presenting the coupon and cycling the robots and weld guns known by those skilled I the art may be used.

In another example, coupon disk 170 can be rotated about axis 176, to present a new or fresh test coupon 178 for more than one robot at an assembly cell or at a sequential assembly cell, so a test coupon is specific to a particular weld gun, or series of weld guns to pinpoint which weld gun, or guns, are in need of maintenance. Various ways of controlling the rotation of base 172 so as to present a new coupon 178 for different weld guns may be used. For example, when a test sample or weld is to be taken, base 172 may be rotated about axis 176 by an adjacent robot 264 to present an unused coupon 178 to an adjacent weld gun robot to cycle and create a test weld 179 as described above. Alternately, the coupon disk 170 may include a registering device or feature which, for example, automatically rotates a predetermined number of degrees to present an unused test coupon to a weld gun as generally described above. Other methods and devices known by those skilled in the art may be used.

In one example, the coupon disk 170 and coupons 178 can be used generate historical data, for example in the form of spot welds, alignment of the spot weld gun tips, seam welds, adhesive beads and other processes, over a period of time which will provide data on the current operating or performance condition of the assembly equipment and advanced notification of the degradation of perishable tooling or equipment in assembly cells 56 and allow proactive measures to prevent a break down or undesirable conditions before they occur. For example, a coupon disk 170 having coupons 178 can be coordinated to have the same weld gun at an assembly station produce a test weld 179 on a specific coupon each time the cart 120 passes through a particular assembly cell. Following several passes of cart 120, a maintenance technician can inspect the coupon and visually see how the welds have changed, for example over a working shift, and ascertain whether there is degradation which requires immediate or proactive service to avoid a problem. Other uses for coupon disk 170 for assembly equipment other than spot weld guns known by those skilled in the art may be used. Further, alternate processes for taking test samples and to generate historical data other than described above may be used.

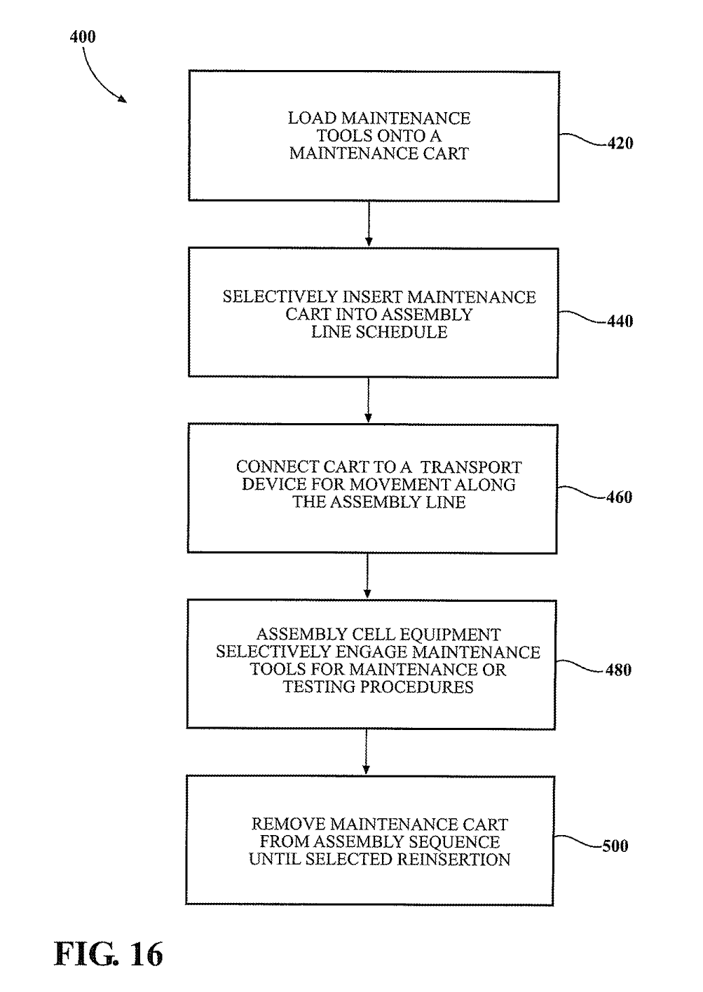

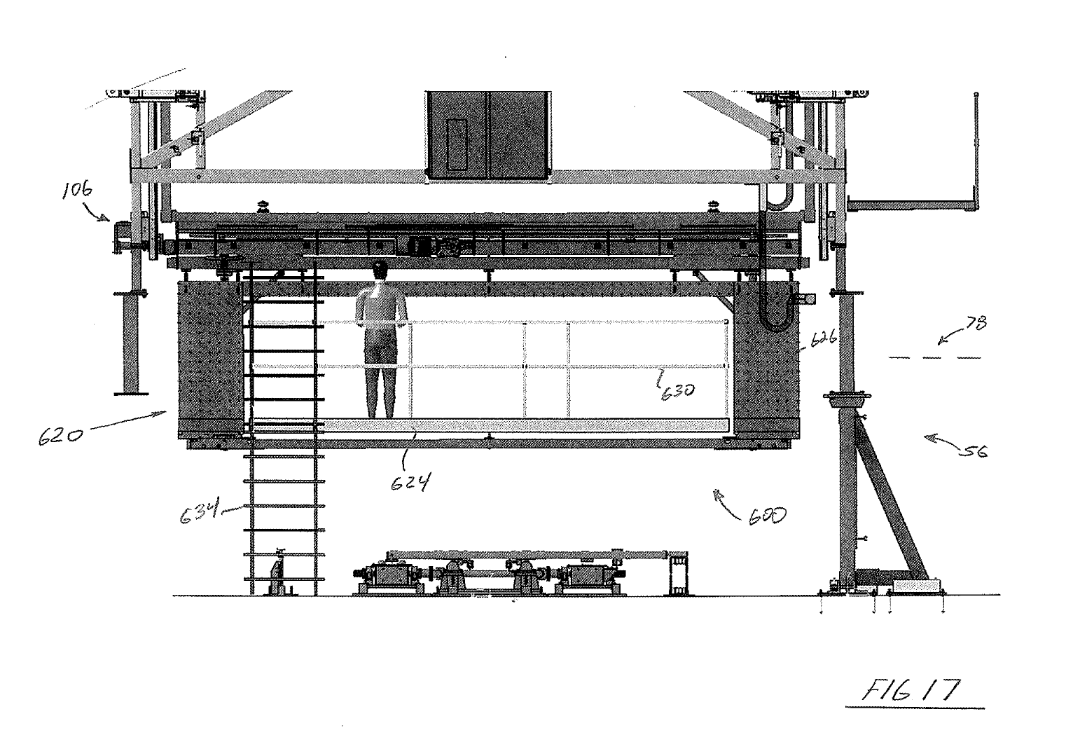

Referring to FIG. 16, an example of the process or method of operation 400 of the system 10 is schematically shown. In the example, step 420 includes loading a plurality of maintenance tools 156 onto a movable cart 120.

In step 440, the cart is selectively inserted into an assembly line sequence or process which includes a plurality of assembly cells 56 having equipment that is compatible with the maintenance tools loaded onto the maintenance cart 120.

In step 460, the cart 120 is engaged with a transport device for movement of the cart 120 along the assembly path 60 and aligned cart path 78.

In step 480, the cart is positioned in one of a plurality of assembly cells where equipment positioned in the assembly cell engage predetermined tools on the cart to conduct maintenance and/or test operations on the equipment. Following completing of the predetermined maintenance or testing processes, the cart 120 is moved from the assembly cell 56 for progression to the next assembly cell for further operations.

In step 500, the maintenance cart is selectively removed from the assembly line sequence to await selected re-insertion into the assembly line for further maintenance or testing processes. In the example, it is understood that depending on the application and necessary maintenance, the cart 120 may continuously remain in the assembly sequence or line until such time as the cart 120 requires refurbishing of the maintenance cart maintenance tools 156, restocking of equipment that replaces perishable equipment in the assembly cell, for example weld guns 168, or for other reasons known by those skilled in the art. In the example shown in FIG. 9, the cart 120 may be temporarily stored in an area 280 until reinsertion of the cart 120 into the assembly sequence is desired. Additional process steps and alternate ordering of the disclosed and illustrated process steps known by those skilled in the art may be used.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An equipment maintenance system for use in an automated vehicle assembly line having a plurality of sequentially positioned assembly cells, the system comprising:
a transport device having a path of travel along an assembly line;
a maintenance cart selectively and removably engaged with the transport for selected movement of the cart along the assembly line; and
at least one of a maintenance tool connected to the cart or a replacement end effector tool positioned on the cart, the respective tool positioned to be accessible by at least one automated robot for service of the robot tooling.

2. The system of claim 1 wherein the cart is selectively positioned between two partially completed vehicles traveling along the assembly line path of travel thereby selectively integrated into the assembly line.

3. The system of claim 2, wherein the transport comprises an overhead conveyor having a plurality of powered rollers, the cart selectively engaged with the rollers to move the cart along the path of travel along the assembly line.

4. The system of claim 3, wherein the transport assembly further comprises at least one lifting device adapted to selectively vertically raise or lower the cart relative to a ground surface in the at least one of the plurality of assembly cells.

5. The equipment maintenance assembly of claim 2, wherein the transport comprises a pallet selectively movable by powered rollers, the cart selectively engaged with the rollers to move the cart along the path of travel along the assembly line.

6. The system of claim 2, wherein the cart comprises a frame having an A-shape configuration and at least one substantially horizontal support deck, the support deck supporting the at least one maintenance tool or replacement tool.

7. The system of claim 6 wherein the cart at least one support deck comprises two support decks, a first deck having at least one maintenance tool connected thereto and a second deck supporting at least one replacement tool.

8. The equipment maintenance assembly of claim 6, wherein the cart support deck includes a plurality of maintenance quadrants, each quadrant being orientated and equipped with a respective maintenance tool or replacement tool accessible by predetermined respective robot positioned in an assembly cell.

9. The system of claim 2 wherein the replacement tool is a replacement resistance spot welding gun, the spot welding gun oriented on the cart for selective and automatic engagement by the robot without human intervention.

10. The equipment maintenance assembly of claim 2, wherein the at least one maintenance tool comprises at least one of a weld tip dressing tool, a test coupon disk or a weld force gauge.

11. The equipment maintenance assembly of claim 2, wherein the at least one test coupon disk comprises:
a base and central column rotatable about a central column axis; and the test
at least one test coupon positioned on the base, the test coupon composing material representative of a production material and production thicknesses desired to be welded by the spot welding gun in the at least one of the plurality of assembly cells.

12. The equipment maintenance assembly of claim 11, wherein the at least one test coupon comprises a plurality of test coupons matching a number of spot welding guns to be tested in the at least one of the plurality of assembly cells, with each test coupon being coordinated to a particular spot welding gun.

13. A method for maintaining tooling for use on an automated robotic vehicle assembly line, the method comprising:
loading at least one of a maintenance tool or a replacement robot end effector tool on a maintenance cart;
removably connecting the maintenance cart to a transport for selective integration of the cart in the assembly sequence;
selectively moving the cart along the assembly line path of travel through a plurality of assembly cells;
positioning the at least one maintenance or replacement end effector tool within a predetermined range of motion of an automated robot to engage the respective tool; and
selectively engaging the automated robot with the at least one maintenance tool or replacement tool.

14. The method of claim 13 wherein the step of removably connecting the cart to the transport further comprises:
selectively inserting the maintenance cart into an assembly sequence of partially completed vehicles traveling along the assembly line path of travel.

15. The method of claim 13 wherein the step of selectively engaging a replacement tool further comprises the steps of:
disengaging an end effector tool from a robot wrist;
engaging the replacement end effector tool with the robot wrist; and
removing the end effector tool from the cart for continued use of the robot in assembly operations.

16. The method of claim 13 wherein the step of selectively engaging a maintenance tool further comprises the step of refurbishing a worn component of a robot end effector tool.

17. The method of claim 13 wherein the step of selectively engaging a maintenance tool further comprises the step of testing a process condition of a robot end effector tool.

18. The method of claim 17 wherein the step of testing a process condition comprises at least one of measuring the quality of a weld, measuring the clamping force of a resistance spot weld gun or measuring the quality of a rivet connection.

19. The method of claim 13 further comprising the step of adjusting the vertical position of the cart relative to a ground surface in an assembly cell.

20. The method of claim 13 further comprising the step of initiating a robot end effector maintenance cycle through preprogrammed movement of the robots on entrance of the cart in the assembly cell.
